(19) United States
(12) Patent Application Publication
(10) Pub. No.: US 2008/0084557 A1
(43) Pub. Date: Apr. 10, 2008

(54) Optical inspection system

(76) Inventors: Wei Song Tan, Marieta, GA (US); David Chiang, Roswell, GA (US); Todd Aldridge Russell, Grayson, GA (US)

Correspondence Address: CIBA VISION CORPORATION;PATENT DEPARTMENT, 11460 JOHNS CREEK PARKWAY, DULUTH, GA, 30097-1556, US

(21) Appl. No.: 11/599,968

(22) Filed: Nov. 15, 2006

Related U.S. Application Data
(60) Provisional application No. 60/737,168, filed on Nov. 16, 2005.

(51) Int. Cl. G01N 21/958; G01N 21/95

(52) U.S. Cl. 356/239.2; 356/237.1

(57) ABSTRACT

The present invention relates to an optical system that allows accurate projection and inspection of a curved surface onto a flat plane. The present invention may be used to prevent or mitigate inspection errors caused by particulate matter by narrowing the depth of field along a curved surface.

This application claims the benefit under 35 U.S.C. § 119 (e) of U.S. provisional application Ser. No. 60/737,168 filed Nov. 16, 2005.

### FIELD OF THE INVENTION

The present invention relates to an optical system that allows accurate projection and inspection of a curved surface onto a flat plane. The present invention may be used to prevent or mitigate inspection errors caused by particulate matter.

### BACKGROUND

Cameras and vision systems are often used in inspection systems, particularly to inspect for defects. However, conventional camera lenses may not be accurate and or/adequate for inspecting curved surfaces because, typically, in an inspection system, the object of the image is projected onto a flat CCD image plane. A technique used to correct this problem is to increase the depth of field of the conventional camera lens by reducing the size of the aperture.

In specific applications, such as for example, contact lens inspection, reducing the size of the aperture introduces additional difficulties. The significant curvature of a contact lens (sagittal height of about 3.5 mm and 14 mm diameter) prevents uniform focus across the surface of the lens. Additionally, for items, such as contact lenses, that float in a liquid solution, when the depth of field is adjusted to capture a 3.5 mm depth, the floating debris in solution is also brought into focus, making inspection techniques inaccurate.

### SUMMARY OF THE INVENTION

The present invention seeks to solve the problems listed herein by providing an optical system to improve the ability to inspect defects on curved surfaces. A particular embodiment includes an optical system that is capable of inspecting defects on the surfaces and sides of contact lenses.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

The present invention provides a method and apparatus for improving inspection resolution by providing a series of optical elements to narrow the depth of field of a digital camera along a specific curved surface. The specific curved surface, in some embodiments, may be a contact lens. The image of the curved surface is preferably projected onto a flat CCD plane. A plurality of optical elements may be used; the adjustable properties of such elements may include front and back surface radii, glass type, spacing between the elements, diameter of the elements, and the thickness of the elements. A range of dimensions may be used for each adjustable property. For example, in one embodiment of the present invention, the front surface radius of the first element is between 50 and 55 mm; the back surface radius of the first element is between −30 and −35 mm; the front surface radius of the second element is between 95 and 100 mm; the back surface radius of the second element is between −15 and −20 mm; the front surface radius of the third element is between −15 and −20 mm; the back surface radius of the third element is between −25 and −30 mm; the front surface radius of the fourth element is between 40 and 45 mm; the back surface radius of the fourth element is between 10 and 15 mm; the front surface radius of the fifth element is between 10 and 15 mm; the back surface radius of the fifth element is between −55 and −60 mm; the front surface radius of the sixth element is between 20 and 25 mm; the back surface radius of the sixth element is between −10 and −15 mm; and the front surface radius of the seventh element is between −15 and −20 mm. In a related embodiment, the diameter of the first element is between 15 and 20 mm; the diameter of the second element is between 15 and 20 mm; the diameter of the third element is between 15 and 20 mm; the diameter of the fourth element is between 15 and 20 mm; the diameter of the fifth element is between 15 and 20 mm; the diameter of the sixth element is between 20 and 25 mm; and the diameter of the seventh element is between 20 and 25.0 mm.

In a similar embodiment, the thickness of the first element is between 1 and 5 mm; the thickness of the second element is between 1 and 5 mm; the thickness of the third element is between 1 and 5 mm; the thickness of the fourth element is between 1 and 5 mm; the thickness of the fifth element is between 5 and 10 mm; the thickness of the sixth element is between 5 and 10 mm; and the thickness of the seventh element is between 1 and 5 mm.

The elements of the present invention may be made of FKS type glass or SFL6 type glass. In more specific embodiments of the present invention using seven optical elements, the front surface radius of said first element may be about 51.9 mm; the back surface radius of said first element may be about −32.0 mm; the front surface radius of said second element may be about 98.4 mm; the back surface radius of said second element may be about −15.8 mm; the front surface radius of said third element may be about −15.8 mm; the back surface radius of said third element may be about −29.9 mm; the front surface radius of said fourth element may be about 40.5 mm; the back surface radius of said fourth element may be about 11.1 mm; the front surface radius of said fifth element may be about 11.1 mm; the back surface radius of said fifth element may be about −58.1 mm the front surface radius of said sixth element may be about 23.5 mm; the back surface radius of said sixth element may be about −13.5 mm; the front surface radius of said seventh element may be about −13.5 mm; and the back surface radius of said seventh element may be about −16.9 mm.

In a related embodiment, spacing between the back of the first element and the front of the second element may be about 0.5 mm; spacing between the back of the second element and the front of the third element may be about 0.0 mm; spacing between the back of the third element and the front of the fourth element may be about 18.3 mm; spacing between the back of the fourth element and the front of the fifth element may be about 0.0 mm; spacing between the back of the fifth element and the front of the sixth element may be about 1.9 mm; and spacing between the back of the sixth element and the front of the seventh element may be about 0.0 mm. In a further related embodiment, the thickness of the first element may be about 3 mm; the thickness of the second element may be about 4 mm; the thickness of the third element may be about 1.7 mm; the thickness of the fourth element may be about 2 mm; the thickness of the fifth element may be about 6.7 mm; the thickness of the sixth element may be about 8.5 mm; and the thickness of the seventh element may be about 2 mm.

### BRIEF DESCRIPTION OF THE DRAWINGS

FIG. 1 illustrates a side view of an optical system of the present invention.

FIG. 2 shows a housing used in conjunction with the present invention.

### DETAILED DESCRIPTION OF THE PREFERRED EMBODIMENTS

Reference now will be made in detail to the embodiments of the invention. It will be apparent to those skilled in the art that various modifications and variations can be made in the present invention without departing from the scope or spirit of the invention. For instance, features illustrated or described as part of one embodiment can be used in conjunction with another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention. All patents and patent applications disclosed herein are expressly incorporated by reference in their entirety.

Unless defined otherwise, all technical and scientific terms used herein have the same meaning as commonly understood by one of ordinary skill in the art to which this invention belongs. Generally, the nomenclature used herein and the manufacturing procedures are well known and commonly employed in the art. Conventional methods are used for these procedures, such as those provided in the art and various general references. Where a term is provided in the singular, the inventors also contemplate the plural of that term.

The present invention seeks to improve the quality of images taken of curved objects that must be projected onto a flat charge-coupled device (CCD) image plane, and hence improve the inspection of curved objects. The present invention allows the camera lens to use a wide open aperture by narrowing the depth of field.

The depth of field defines the zone in which all elements show clearly from foreground to background. The depth of field in an image is controlled by three factors: the distance to the subject, the focal length, and the aperture used to capture the image. It is necessary to understand that the term depth of field defines a somewhat “elastic” concept: acceptable sharpness. The perception of sharpness can differ from one individual to another, and when the expression “depth of field” is used, it really denotes that area in an image that exhibits a sufficient sharpness to be considered more or less in focus for a particular application. The depth of field doesn't have to be one of precise sharpness, but instead that portion of the image in which things remain recognizable for what they are and for their intended purpose. For example, in an inspection system the sharpness must be such that any possible defects, if present, are clear.

For digital cameras, depth of field is a subject of special interest because depth of field is more difficult to control than earlier film cameras. In digital cameras, such as CCD cameras, incoming light is received by a piece of silicon called a charge-coupled device (CCD). This silicon wafer is a solid-state electronic component which has been micro-manufactured and segmented into an array of individual light-sensitive sells that are referred to as pixels. The small imaging sensors of compact cameras require the use of short focal lengths, and this in turn gives these cameras an unusually long depth of field when compared to 35 mm cameras. Thus, intentionally getting a shallow depth of field is more difficult.

As a rule, depth of field decreases as the subject gets closer to the camera; meaning that as the point of focus gets closer to the lens, the possible extent of the depth of field diminishes. On the other hand, if the subject is far enough away from the camera—and for compact digital cameras, this need not be very far—the depth of field extends out to infinity.

In the present invention, the point of focus is preferably closer to the camera lens. In an exemplary inspection system, such as that used for a contact lens, the contact lens to be inspected is preferably about 35 to 55 mm from the camera in order to bring the defects such as tears or gaps into focus. Other distances, however, may be used with different configurations of the optical and inspection systems. Obtaining a sharp image of the curved surface is accomplished in the present invention by using a system of optical elements to project the image of the contact lens onto a CCD image sensor. The present invention allows improved inspection by narrowing the depth of field according to the curvature of a curved surface using one or more optical elements. In a typical contact lens inspection system, however, the contact lens is in a wet cell or saline solution. Oftentimes, particulate matter may be present in the wet cell. Hence, automatic focus of a digital camera used in inspection may inadvertently include or focus upon such particulate matter. In effect, narrowing the depth of field according to the curvature allows the camera to see a thin curved “slice” of focus that prevents measurements that include particulate matter

In one embodiment, the optical system includes multiple optical elements. Each optical element preferably has a front and back surface radius measured in mm. Additionally, each optical element has a diameter from about 15 mm to 25 mm. The optical elements are preferably made from glass, specifically FK3 or SFL6 type glass. Increasing numbers of optical elements provide better focus and accuracy.

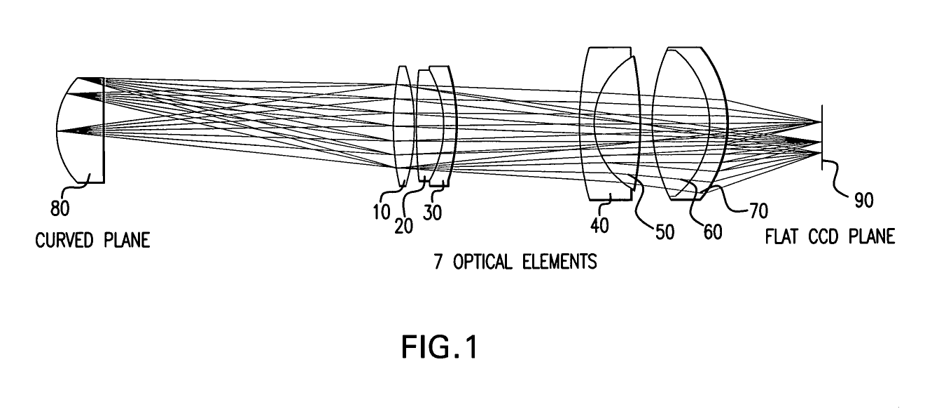

In a specific embodiment, as depicted in FIG. 1, a system of optical elements is physically placed between the curved surface or plane 80 to be imaged and a flat CCD plane 90. A first optical element 10 may have a front surface radius between 50 and 55 mm and a back surface radius between −30 and −35 mm. The first element may also have a diameter between 15 and 20 mm and may be made of FK3 type glass. A second optical element 20 may have a front surface radius between 95 and 100 mm and a back surface radius between −15 and −20 mm. The second element may also have a diameter between 15 and 20 mm and may be made of FK3 type glass. A third optical element 30 may have front surface radius of between −15 and −20 mm and back surface radius between −25 and −30 mm. The third element may also have a diameter between 15 and 20 mm and may be made of SFL6 type glass. A fourth optical element 40 may have a front surface radius between 40 and 45 mm and a back surface radius between 10 and 15 mm. The fourth element may have a diameter between 15 and 20 mm diameter and may be made of SFL6 type glass. A fifth optical element 50 may have a front surface radius of about between 10 and 15 mm and a back surface radius of between −55 and −60 mm. The fifth element may also have a diameter between 15 and 20 mm diameter and may be made of FK3 type glass. A sixth optical element 60 preferably may have a front surface radius of between 20 and 25 mm and a back surface radius of between −10 and −15 mm. The sixth element may also have a diameter between 20 and 25 mm and may be made of FK3 type glass. A seventh optical element 70 preferably has a front surface radius between −10 and −15 mm and a back surface radius between −15 and −20 mm. The seventh element may also have a diameter between 20 and 25 mm and may be made of SFL6 type glass.

In another embodiment of the present invention, the spacing between the back of first element 10 and the front of second element 20 may be between 0 and 5 mm. The spacing between the back of second element 20 and the front of third element 30 may include a range from 0 to 5 mm. The spacing between the back of third element 30 and the front of fourth element 40 may be between 15 and 18 mm. The spacing between the back of fourth element 40 and the front of fifth element 50 may include a range from 0 to 5 mm. The spacing between the back of the fifth element 50 and the front of the sixth element 60 may be between 1 and 5 mm. The spacing between the back of the sixth element 60 and the front of the seventh element 70 may include a range from 0 to 5 mm.

In still another embodiment of the present invention the thickness of each optical element may vary. In an embodiment in which seven optical elements are used, the thickness of the first, second, third, fourth and seventh elements may be between 1 and 5 mm. The thickness of the fifth and sixth elements may be between 5 and 10 mm.

One specific embodiment of the present invention includes the radii, spacing, and diameters in the chart below. The term “spacing” is defined as the distance between the back of that element and the front of the next element.

| Optical | Front Surface | | Back Surface | | | | | | | |
|---|---|---|---|---|---|---|---|---|---|---|
| Element | Radius | | Radius | | Thickness | | Diameter | | Spacing | |
| 1 | 51.9 | mm | −32.0 | mm | 3 | mm | 16 | mm | 0.5 | mm |
| 2 | 98.4 | mm | −15.8 | mm | 4 | mm | 16 | mm | 0.0 | mm |
| 3 | −15.8 | mm | −29.9 | mm | 1.7 | mm | 17.2 | mm | 18.3 | mm |
| 4 | 40.5 | mm | 11.1 | mm | 2 | mm | 19.2 | mm | 0.0 | mm |
| 5 | 11.1 | mm | −58.1 | mm | 6.7 | mm | 19.2 | mm | 1.9 | mm |
| 6 | 23.5 | mm | −13.5 | mm | 8.5 | mm | 21.0 | mm | 0.0 | mm |

| | | | | | | | | | |
|---|---|---|---|---|---|---|---|---|---|
| 7 | −13.5 | mm | −16.9 | mm | 2 | mm | 22.0 | mm | N/A |

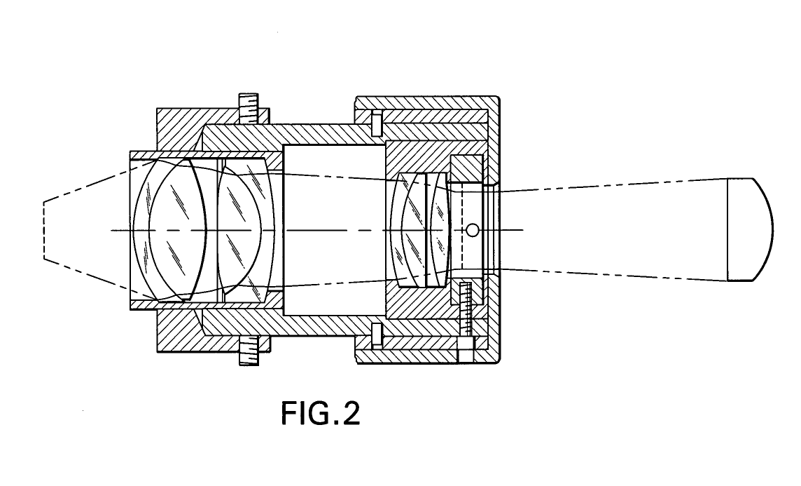

This optical system is preferably contained in a housing as depicted in FIG. 2. The housing preferably has a mechanism that can finely adjust the distance between the seventh optical element 70 and the CCD plane for focusing purposes. It may also have an adjustable aperture to control the amount of light that passes through the optical system to control the image intensity and the depth of field.

The invention has been described in detail, with particular reference to certain preferred embodiments, in order to enable the reader to practice the invention without undue experimentation. Some of these embodiments include specific measurements, which are exemplary only and do not constitute the full scope of the invention. A person having ordinary skill in the art will readily recognize that many of the previous components, compositions, and/or parameters may be varied or modified to a reasonable extent without departing from the scope and spirit of the invention. Furthermore, titles, headings, example materials or the like are provided to enhance the reader's comprehension of this document, and should not be read as limiting the scope of the present invention. Accordingly, the invention is defined by the following claims, and reasonable extensions and equivalents thereof.

What is claimed is:

1. An apparatus for improving inspection resolution comprising providing a series of optical elements, wherein said elements narrow the depth of field of a digital camera along a specific curved surface.

2. The apparatus of claim 1, wherein an image of said specific curved surface is recorded and projected onto a flat CCD plane.

3. The apparatus of claim 1, wherein said series of optical elements further comprises 7 optical elements, wherein:
the front surface radius of said first element is about 51.9 mm;
the back surface radius of said first element is about −32.0 mm;
the front surface radius of said second element is about 98.4 mm;
the back surface radius of said second element is about −15.8 mm
the front surface radius of said third element is about −15.8 mm;
the back surface radius of said third element is about −29.9 mm;
the front surface radius of said fourth element is about 40.5 mm;
the back surface radius of said fourth element is about 11.1 mm;
the front surface radius of said fifth element is about 11.1 mm;
the back surface radius of said fifth element is about −58.1 mm;
the front surface radius of said sixth element is about 23.5 mm;
the back surface radius of said sixth element is about −13.5 mm;
the front surface radius of said seventh element is about −13.5 mm; and
the back surface radius of said seventh element is about −16.9 mm.

4. The apparatus of claim 1 wherein the optical elements are made from a material selected from the group consisting of: FKS type glass and SFL6 type glass.

5. The apparatus of claim 1, further comprising:
spacing between the back of the first element and the front of the second element is about 0.5 mm;
spacing between the back of the second element and the front of the third element is about 0.0 mm;
spacing between the back of the third element and the front of the fourth element is about 18.3 mm;
spacing between the back of the fourth element and the front of the fifth element is about 0.0 mm;
spacing between the back of the fifth element and the front of the sixth element is about 1.9 mm; and
spacing between the back of the sixth element and the front of the seventh element is about 0.0 mm.

6. The apparatus of claim 1, wherein
the diameter of the first element is about 16.0 mm;
the diameter of the second element is about 16.0 mm;
the diameter of the third element is about 17.2 mm;
the diameter of the fourth element is about 19.2 mm;
the diameter of the fifth element is about 19.2 mm;
the diameter of the sixth element is about 21.0 mm; and
the diameter of the seventh element is about 22.0 mm.

7. The apparatus of claim 1, wherein
the thickness of the first element is about 3 mm;
the thickness of the second element is about 4 mm;
the thickness of the third element is about 1.7 mm;
the thickness of the fourth element is about 2 mm;
the thickness of the fifth element is about 6.7 mm;
the thickness of the sixth element is about 8.5 mm; and
the thickness of the seventh element is about 2 mm.

8. The apparatus of claim 1, wherein said curved surface is a contact lens

9. A method for improving inspection resolution by providing a at least 7 optical elements that narrow the depth of field of a digital camera to a specific curvature, wherein
the front surface radius of said first element is between 50 and 55 mm;
the back surface radius of said first element is between −30 and −35 mm;
the front surface radius of said second element is between 95 and 100 mm;
the back surface radius of said second element is between −15 and −20 mm;
the front surface radius of said third element is between −15 and −20 mm;
the back surface radius of said third element is between −25 and −30 mm;
the front surface radius of said fourth element is between 40 and 45 mm;
the back surface radius of said fourth element is between 10 and 15 mm;
the front surface radius of said fifth element is between 10 and 15 mm;
the back surface radius of said fifth element is between −55 and −60 mm
the front surface radius of said sixth element is between 20 and 25 mm;
the back surface radius of said sixth element is between −10 and −15 mm; and
the front surface radius of said seventh element is between −15 and −20 mm.

10. The method of claim 9, wherein
the diameter of the first element is between 15 and 20 mm;
the diameter of the second element is between 15 and 20 mm;
the diameter of the third element is between 15 and 20 mm;
the diameter of the fourth element is between 15 and 20 mm;
the diameter of the fifth element is between 15 and 20 mm;
the diameter of the sixth element is between 20 and 25 mm; and
the diameter of the seventh element is between 20 and 25.0 mm.

11. The method of claim 9, wherein
the thickness of the first element is between 1 and 5 mm;
the thickness of the second element is between 1 and 5 mm;
the thickness of the third element is between 1 and 5 mm;
the thickness of the fourth element is between 1 and 5 mm;
the thickness of the fifth element is between 5 and 10 mm;
the thickness of the sixth element is between 5 and 10 mm; and
the thickness of the seventh element is between 1 and 5 mm.

12. The method of claim 9, wherein said curved surface is a contact lens.

13. The method of claim 9, wherein the optical elements are made from a material selected from the group consisting of: FKS type glass and SFL6 type glass.

14. A method for improving inspection resolution by providing a at least 7 optical elements that narrow the depth of field of a digital camera to a specific curvature.
